(19) United States
(12) Patent Application Publication
(10) Pub. No.: US 2018/0020441 A1
(43) Pub. Date: Jan. 18, 2018

(54) COLLABORATIVE TRANSMISSION BY MOBILE DEVICES

(71) Applicant: Titus Lo, Bellevue, WA (US)

(72) Inventor: Titus Lo, Bellevue, WA (US)

(21) Appl. No.: 15/545,907

(22) PCT Filed: Jan. 21, 2016
(86) PCT No.: PCT/US16/14347

§ 371 Date: Jul. 24, 2017

Related U.S. Application Data
(60) Provisional application No. 62/107,444, filed on Jan. 25, 2015.

(51) Int. Cl. H04W 72/04; H04W 76/02; H04W 40/24; H04W 40/22; H04W 40/32; H04W 8/00; H04W 88/04

(52) U.S. Cl. CPC H04W 72/0406; H04W 40/32; H04W 76/023; H04W 72/044; H04W 8/005; H04W 40/244; H04W 40/22; H04W 88/04

(57) ABSTRACT

Methods, apparatus, and other technology are disclosed for collaborative transmission in a wireless communication system. In one embodiment, a transmitter receives control information from a receiver in the wireless communication system. The control information indicates time-frequency resources allocated or assigned for data transmission by the transmitter. The transmitter sends configuration information to a second transmitter in the wireless communication system. The configuration information includes indication of the time-frequency resource allocation or assignment. The transmitter to the second transmitter the data which to be transmitted to the receiver using the allocated time-frequency resources.

### CROSS-REFERENCE TO RELATED APPLICATION(S)

This application claims priority to and is a 35 U.S.C. §371 national stage entry of International Application No. PCT/US2016/014347, which claims the benefit of U.S. Provisional Patent Application No. 62/107,444, filed on Jan. 25, 2015. Each of the afore-referenced application(s) is hereby incorporated by reference.

### BACKGROUND

In many wireless networks, a base station provides service coverage to a designated area, usually called a cell. The transmission from the base station to a mobile device in the cell is called a downlink (DL) transmission and the transmission from a mobile device to a base station is called an uplink (UL) transmission. Although the term “mobile device” is used throughout this specification, it can generally mean a remote device, a nomadic device, or a device that wirelessly communicates with the serving base station. A DL signal is usually much stronger than an UL signal because, for example, the base station can employ a high power transmitter whereas the mobile device may only be equipped with a transmitter with very limited transmission power, e.g., because of size and/or battery constraints. This DL/UL power imbalance is one of the major contributing factors to the DL/UL imbalance problem in link budgets, especially for mobile devices at the far edge of the cell.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale.

For a better understanding of the present invention, reference will be made to the following Detailed Description, which is to be read in association with the accompanying drawings, wherein:

FIG. 1 is a graphical depiction of a representative diagram of a wireless system.

FIG. 2 is a graphical depiction of the interaction between two mobile devices over a PTP link.

FIG. 3 is a graphical depiction of the uplink physical channel processing.

FIG. 4 is a graphical depiction of collaborative transmission by mobile devices.

FIGS. 5A-5C are graphical depictions of various ways for sending configuration information and data from an initiator to a donor.

FIG. 6 is a graphical depiction of full use of component carriers for collaborative transmission by mobile devices.

FIG. 7 is a graphical depiction of partial use of component carriers for collaborative transmission by mobile devices.

FIG. 8 is a graphical depiction of split use of component carriers for collaborative transmission by mobile devices.

FIG. 9 illustrates an example of an operational procedure for practicing aspects of the present disclosure by an initiator.

FIG. 10 illustrates an example of an operational procedure for practicing aspects of the present disclosure by a donor.

### DETAILED DESCRIPTION

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of embodiments of the technology. It is intended that the terminology used in this disclosure be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section. For example, the term “based on” or “based upon” is not exclusive and is equivalent to the term “based, at least in part, on” and includes being based on additional factors, some of which are not described herein. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof.

Methods, apparatus, and other technology for collaborative transmission by mobile devices are disclosed. The technology includes use of “donor” mobile device(s) to assist an “initiator” mobile device in transmitting data to a serving base station. For example, the donor may transmit data to the serving base station on behalf of the initiator. The donor may also transmit such data using time and/or frequency slots or other resources as instructed by the initiator. Such resources may be the same as those used by the initiator in the initiator's own transmissions to the serving base station.

In one example, the donor transmits to the service base station using the same time and same frequency allocation that the initiator uses for the initiator's own transmissions. In this way, multiple mobile devices transmit the same waveform at the same time to the serving base station. When the waveforms transmitted by the mobile devices reach the serving base station, they may superimpose into a stronger or more robust signal for the base station to detect, receive, or decode.

The disclosed technology may be employed, for example, to address DL/UL imbalance issues with, or instead of, using robust modulation and coding schemes (MCS) and/or narrower bandwidth for UL transmission than for the DL. Accordingly, the disclosed technology may be beneficial at least because it improves UL performance without many of the disadvantages of increasing MCS strength or reducing UL bandwidth.

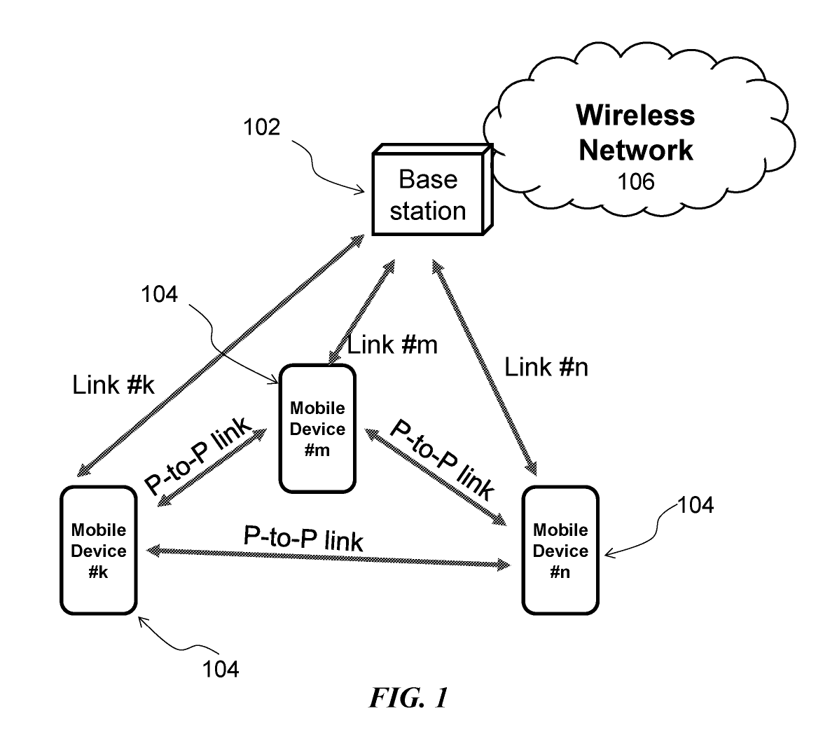

FIG. 1 is a representative diagram of a wireless system in accordance with various embodiments of the present invention. The wireless network 106 can be a mobile network employing cellular technology such as the Long-Term Evolution (LTE) technology, where the DL transmission scheme is based on conventional Orthogonal Frequency Division Multiplexing (OFDM) and the UL transmission scheme is based on Single-Carrier Frequency Division Multiple Access (SC-FDMA) or Discrete Fourier Transform Spread (DFTS)-OFDM. The wireless network 106 can be connected to another network or cloud (not illustrated), which can be public or private. There is a group of two or more mobile devices 104 wirelessly connected to a serving base station 102 in the wireless network. Although two mobile devices are illustrated in some of the examples provided herein, the method, process, mechanism, apparatus, or other technology disclosed herein can be employed with any suitable number of mobile devices.

In addition to the capability of communicating with their serving base station 102 in the wireless network 106, mobile devices 104 have the ability to communicate with each other using other wireless technologies. For example, two or more mobile devices may communicate with each other using wireless local area network (WLAN) technology (e.g., IEEE802.11 or WiFi), such as in a peer-to-peer (PTP) or device-to-device (D2D) mode (e.g., ad-hoc mode or WiFi direct mode), infrastructure mode, or in a mesh network. They may also communicate with each other using Bluetooth, near field communication (NFC), Ethernet, or any other suitable technologies.

In accordance with various embodiments of the present invention, mobile devices can join or form a group to collaborate in transmission to a serving base station. A collaborative UL group can be formed in a specific location, area, or zone where collaborative transmission is beneficial and the mobile devices in the collaborative UL group may be able to communicate with each other via PTP or other local links. The collaborative zone may be designated or identified by the serving base station or the wireless network that the serving base station is associated with. An identifier may be provided or assigned to the collaborative UL group by the serving base station or by another network element.

The formation of a collaborative UL group can be initiated by the serving base station, by a mobile device, or by another network element. For example, if the serving base station determines that it is beneficial for a mobile device at in particular zone to join or form a collaborative UL group, it can send a control message or a sequence of control messages to the mobile device to facilitate the mobile device to join or form the collaborative UL group. A control message from the serving base station may include one or more of the following: an indication of allowing UL collaborative transmission, an identifier for the collaborative UL group, a command to join or form the collaborative UL group, an authentication code, an encryption key, and/or an indication of a type of error correction/detection code. Alternatively, if a mobile device determines that it is beneficial for it to join or form a collaborative UL group, it may initiate steps to join or form the collaborative UL group. The determination may be based on a combination of parameters including signal strength, signal-to-noise ratio (SNR), signal-to-interference plus noise ratio (SINR), error rate, modulation and coding scheme (MCS), transmission power level, channel-bandwidth requirement, quality of service (QoS) requirement, location, and/or other measures or requirements.

As referred to herein, within the collaborative UL group, the mobile device that has its own data to be transmitted to the base station via UL collaboration with another mobile device is the initiator, and the mobile device that potentially transmits data on behalf of the initiator is the donor. In collaborative UL transmission, some or all of processes, procedures, and/or parameters at the media access control (MAC) layer and/or the physical layer carried out by the initiator may be cloned or otherwise employed by the donors. The mobile devices in the collaborative UL group may be synchronized with the serving base station and transmit a common uplink (UL) data packet using the same or other shared time-frequency resources.

In some embodiments, the serving base station may provide authentication codes or/and encryption keys to the collaborative UL group to establish the PTP or local connections between the mobile devices. In the case of WiFi connections, one or more predetermined service set identifications (SSIDs) and the corresponding pass-phrases may be provided or assigned for the use by the mobile devices in the collaborative UL group. In the case of Bluetooth connections, one or more predetermined authentication codes or passkeys are provided to the mobile devices for secure simple pairing (SSP), or alternatively, one or more predetermined universal unique identifiers (UUIDs) are provided if the service discovery protocol (SDP) is used.

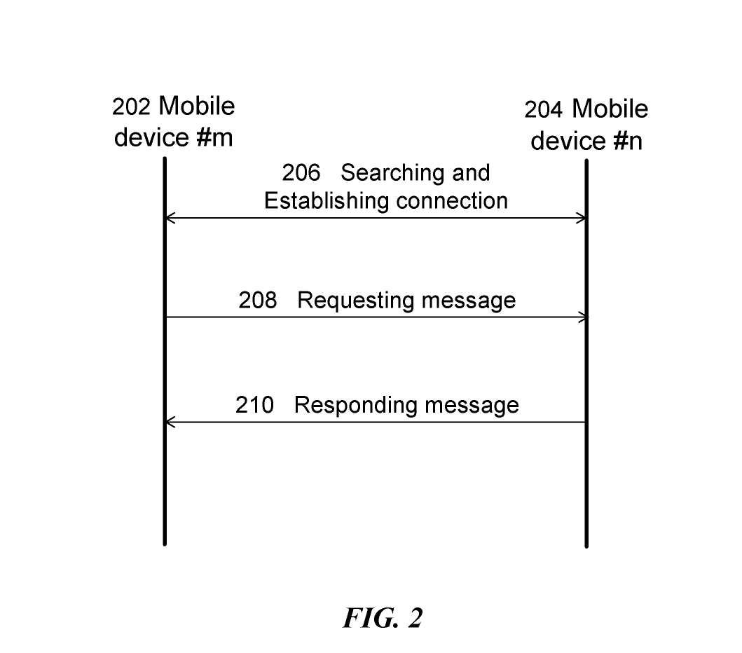

To joint or form a collaborative UL group, a mobile device may, for example, search for, in a PTP discovery mode, other mobile device(s) within its reach (e.g., signal range) that may be enabled to perform collaborative transmission, as depicted in FIG. 2. For example, mobile device #m 202 may send out beacon signals and if mobile device #n 204 receives the beacon signal it may choose to respond to mobile device #m and start a handshaking procedure 206 to establish the PTP or other local connection with each other. Once the connection is established, one of them (e.g., mobile device #m) may send a message 208 to request specific information (e.g., device capability) from the other mobile device (e.g., mobile device #n). In a response message 210, the other mobile device may provide the requested information. The requested information may include one or more parameters indicating the capability of the corresponding mobile device, such as its ability to support collaborative UL transmission, supported bandwidth, its carrier-aggregation capability, its number of transmission antennas, and/or its present battery power level.

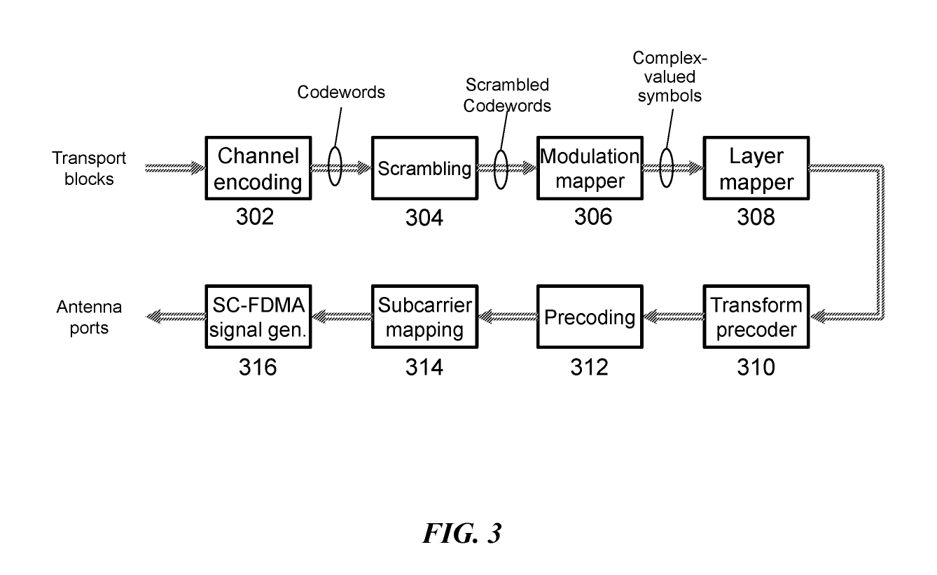

FIG. 3 shows a typical uplink physical channel processing, where data to be transmitted go through channel encoding 302, scrambling 304, modulation mapping 306, layer mapping 308, transform precoding 310, precoding 312, subcarrier mapping 314, and signal generation 316.

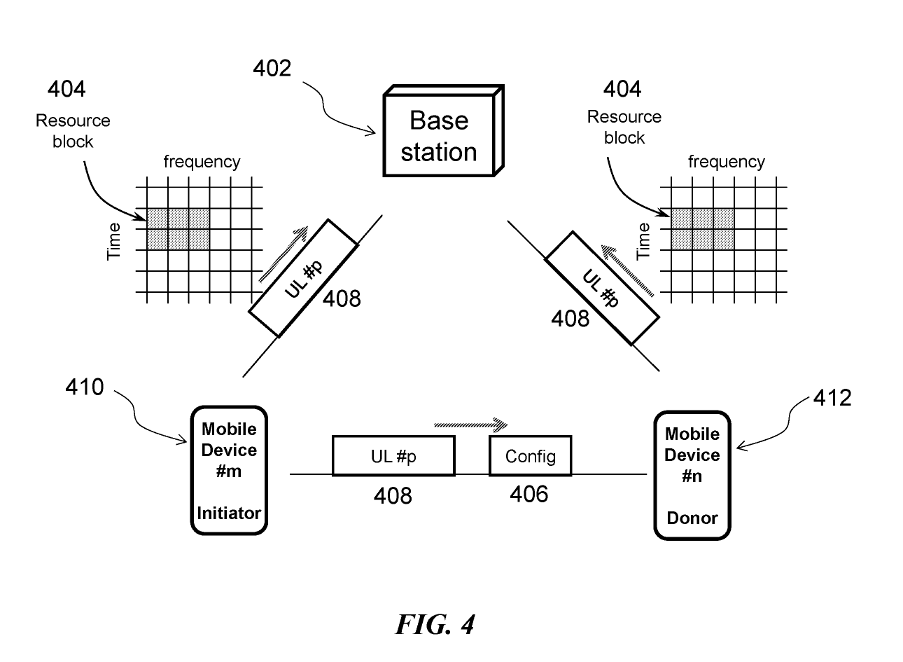

In collaborative transmission, the mobile devices in the collaborative UL group may be synchronized with the serving base station in time and frequency. The mobile devices 104 in the collaborative UL group may transmit the same UL data packet using the same time-frequency resources 404 (e.g., resource blocks or elements of the same time indices and frequency indices), as shown in FIG. 4. For example, time-frequency resources may be defined using time and/or frequency indices. A time index may be associated with a frame number, a subframe number, slot number, an SC-FDMA symbol number, and/or any combination of the forgoing. A frequency index may be associated with a component carrier identity, a resource block number, and/or a subcarrier (or resource element) number. The data to be collaboratively transmitted may be processed using the same algorithms or procedures by the initiator 410 and donors 412 in the collaborative UL group. For example, the data will be encoded, scrambled, modulation-mapped, layer-mapped, transformed, precoded, subcarrier-mapped, and/or signal-generated by the donors in the same way as by initiator in the collaborative UL group hence resulting in the same or similar output as from the initiator.

When the initiator has data to send to the serving base station, it may request for UL resources to be allocated by the serving base station. The serving base station 402 may allocate the UL resource associated with a specific scheduling scheme (e.g., dynamic scheduling or semi-persistent scheduling) to the initiator 410. The serving base station may also indicate whether or not the UL transmission can be carried out collaboratively. However, the initiator 410 may decide to carry out the scheduled UL transmission collaboratively, with or without the permission of the serving base station.

In some embodiments, the data that is scheduled for collaborative transmission is sent from the initiator 410 to the donors 412 via a PTP or other local connection, as depicted in FIG. 4. The data may be in the format of a transport block, a codeword, or a scrambled codeword. In the case of transport blocks, a donor may process the data from the channel encoding step to the signal generating step in the same way as the initiator. In the case of codewords, a donor may process the data from the scrambling step to the signal generating step in the same way as the initiator. In the case of scrambled codewords, a donor may process the data from the modulation mapping step to the signal generating step in the same way as the initiator.

In other embodiments, uplink control data (e.g., control information bits or symbols, a random access preamble, a sounding reference signal, and/or an indication of a uplink control channel) may be collaboratively transmitted to the serving base station 402. The UL control data may be sent from the initiator 410 to a donor 412, which may spread the control data with a spreading sequence and map the spread bits or symbols to the subcarriers to generate the SC-FDMA signals in the same way as the initiator. The spreading sequence may be a binary or non-binary, orthogonal or near-orthogonal sequence. The spreading sequence may be specific to an antenna port.

In an embodiment, the power control is applied to collaborative transmission. The initiator may indicate a specific transmission power level to a donor. In some cases, the initiator 410 and the donor 412 may use the same level of transmission power. In other cases, they may use different levels of transmission power. A power level of collaborative transmission may be determined by a specific parameter or dictated by the serving base station. The collaborative transmission power level may be set proportionally lower than the transmission power level in the case where initiator transmits alone. The collaborative transmission power level for each mobile device (either the initiator or a donor) may be based on its current battery level.

In accordance with various embodiments of the present invention, the initiator 410 may send, via, for example, a PTP or local connection, the collaborative transmission data 408 and the associated configuration information 406 to a donor 412 in the collaborative UL group.

In some embodiments, the configuration information 406 may include at least one of these parameters:
one or more parameters for identifying the serving base station and the initiator (e.g., a cell ID, and/or an Radio Network Temporary Identifier (RNTI));
one or more parameters for a scheduled transmission (e.g., a frame number, a time slot index, a resource block number, an indication of bandwidth for uplink transmission, an indication of normal or extended cyclic prefix, an indication of subcarrier spacing, an indication of a component carrier, an indication of uplink shared channel, and/or an indication of physical uplink control channel (PUCCH) format);
one or more parameters for reference signal configurations (e.g., an indication of a cyclic shift for a reference signal sequence, an indication of demodulation reference signal configuration, an indication of preamble format, an indication of random access preamble configuration, an indication of sounding reference signal (SRS) configuration, and/or an indication of a group hopping pattern);
one or more parameters for transmission configurations (e.g., an indication of an uplink bandwidth configuration, a codeword number, a number of modulation symbols per layer, a number of modulation symbols to transmit on a physical channel, an indication of a frequency hopping function, an indication of transmit power level, and/or an index for the orthogonal spread sequence);
one or more parameter for antenna configurations (e.g., a number of antenna ports used for transmission on a channel, an antenna port number, an indication of a precoding matrix, and/or a codebook index).

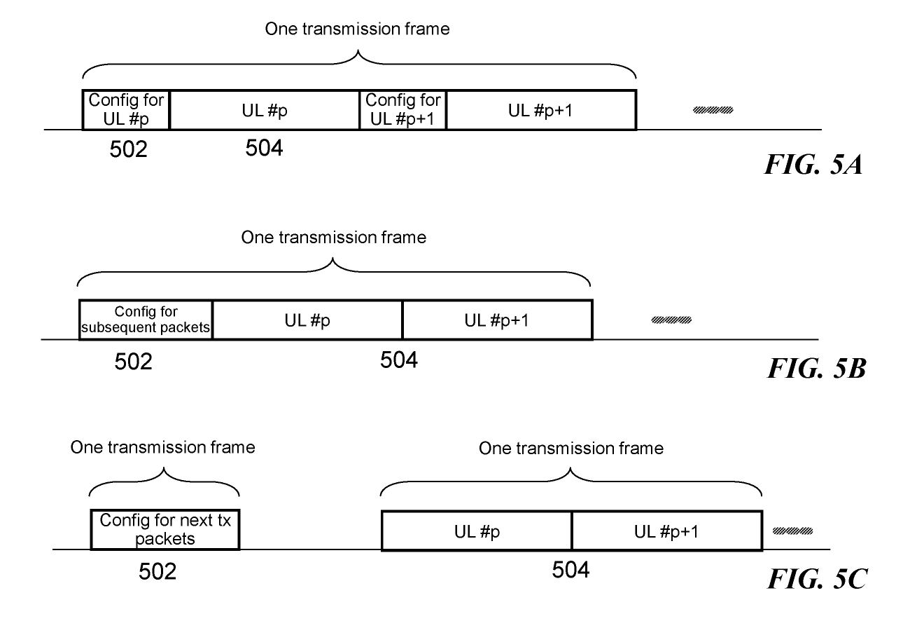

FIGS. 5A-5C are graphical depictions of various ways for sending configuration information and data from an initiator to a donor. As depicted in FIGS. 5A-5C, the configuration information 502 and data 504 may be sent from the initiator to the donors in the same PTP transmission frame (FIGS. 5A and 5B) or in different PTP transmission frames (FIG. 5C),. For example, the configuration information and the data may be contained in the same physical layer convergence procedure (PLCP) service data unit (PSDU). The data 504 may comprise one or more UL data packets. An information block may precede or follow a UL packet to provide information of the transmission configuration for this packet. Alternatively, configuration information 502 for multiple of UL packets may be aggregated in one information block (FIGS. 5B and 5C), which may precede, follow, or be situated in between multiple UL packets. In other cases, the configuration information and the UL packets may be sent in different or separate frames (or PSDUs).

In some embodiments, the initiator may request a donor in the collaborative UL group to transmit UL data packets to the serving base station while the initiator itself does not transmit directly to the base station. However, the initiator may receive DL transmissions directly from the base station.

The donor may also validate the received data from an initiator before transmitting it to the base station. For example, it may validate a checksum, hash, parity, or other suitable information. If an error in the received PTP or other local transmission (e.g., a PSDU) from the initiator is detected by a donor in the collaborative UL group, this donor may discard the received erroneous local transmission and it will not participate in collaborative transmission of the UL packet or packets associated with the received erroneous local transmission.

Further, the donor may also validate the availability of the donor to transmit the data to the base station. For example, a donor may determine whether there is a schedule conflict between a requested transmission for an initiator and a transmission of the donor's own data. A scheduling conflict may occur when two transmissions are scheduled to use a common part or the whole of a resource block. A scheduling conflict may also occur when two transmissions are scheduled in the same time slot or the same OFDM symbol. If the scheduled collaborative transmission conflicts with a scheduled transmission of a donor's data, this donor could not participate in the scheduled collaborative transmission but may instead carry out its own scheduled transmission.

The donor may also arbitrate conflicts between requests from multiple initiators. For example, if a donor receives requests from two initiators for collaborative transmissions that happen to be in a scheduling conflict, the donor may choose to not participating in any of the scheduled collaborative transmissions in the scheduling conflict, randomly select one of the two scheduled collaborative transmissions to carry out, or select one of the two scheduled collaborative transmissions that has a higher priority. The priority may be in terms of the time order of request (e.g., earlier or later), the level of quality of service, and/or the content of the UL packet (e.g., control information vs. data).

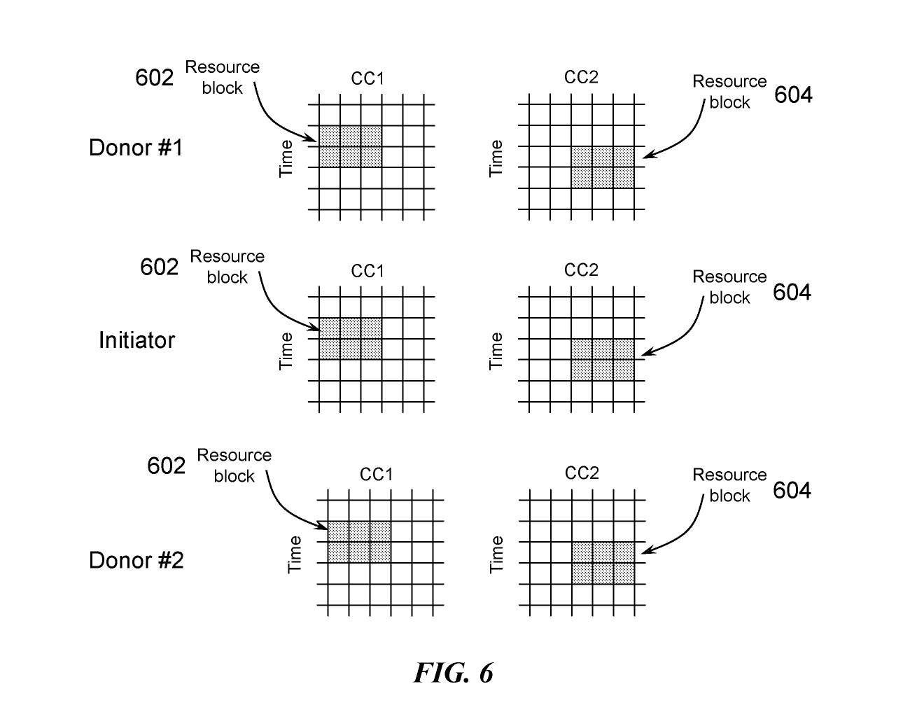

The method, process, mechanism, or apparatus for collaborative transmission by mobile devices can be extended to the cases of carrier aggregation. In UL carrier aggregation, a mobile device may be able to transmit to the serving base station using more than one frequency band or component carrier (CC). In one embodiment, the initiator and a donor may carry collaborative transmission on multiple component carriers. For example, in the case of two component carriers (CC1 and CC2) depicted in FIG. 6, on each carrier component, the initiator and the two donors may transmit a common data packet using the same resource block(s) 602 on CC1 and another common data packet using the same resource block(s) 604 on CC2. In this case, the donors donate resources on both CCs to the initiator for collaborative transmission.

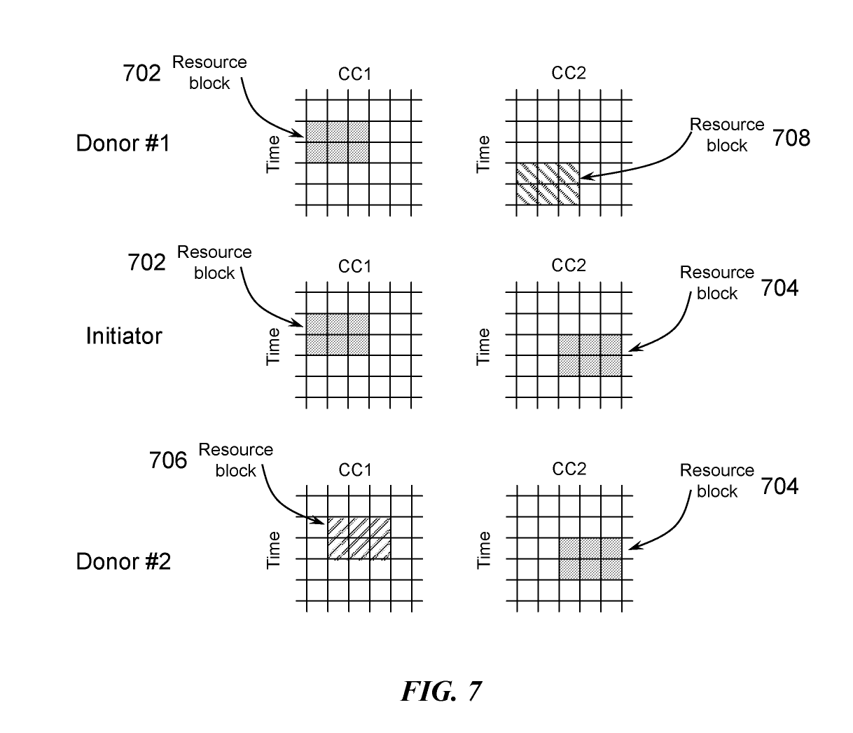

In another embodiment, a donor may only donate resources on some of the component carriers to an initiator for collaborative transmission and retain resources on the rest of the component carriers for its own data transmission. For example, in the case depicted in FIG. 7, the initiator and donor #1 may transmit a common data packet using the same resource block(s) 702 on CC1 while donor #1 may reserve the resource blocks 708 on CC2 for its own data transmission. Furthermore, the initiator and donor #2 may transmit another common data packet using the same resource block(s) 704 on CC2 while donor #2 may reserve the resource blocks 706 on CC1 for its own data transmission.

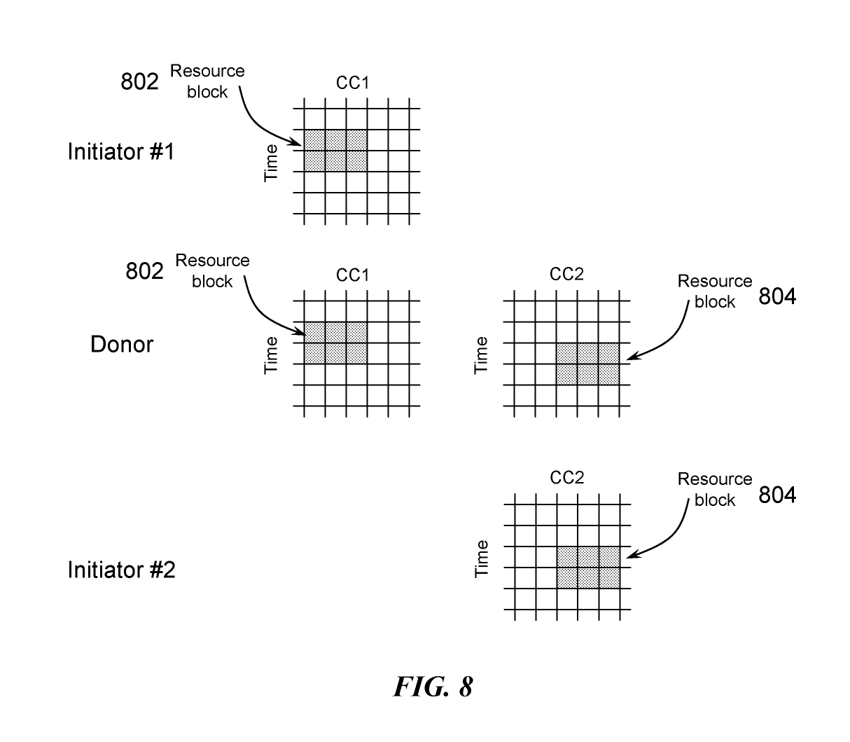

In still another embodiment, a donor may donate resources on some of the component carriers to multiple initiators for collaborative UL transmission. For example, in the case depicted in FIG. 8, initiator #1 and the donor may transmit a common data packet using the same resource block(s) 802 on CC1 while initiator #2 and the donor may transmit another common data packet using the same resource block(s) 804 on CC2.

For clarity, the processes described herein are described in terms of operations performed in particular sequences by particular devices or components of a system. However, it is noted that other processes are not limited to the stated sequences, devices, or components. For example, certain acts may be performed in different sequences, in parallel, omitted, or may be supplemented by additional acts or features, whether or not such sequences, parallelisms, acts, or features are described herein. Likewise, any of the technology described in this disclosure may be incorporated into the described processes or other processes, whether or not that technology is specifically described in conjunction with a process. The disclosed processes may also be performed on or by other devices, components, or systems, whether or not such devices, components, or systems are described herein. These processes may also be embodied in a variety of ways. For example, they may be embodied on an article of manufacture, e.g., as computer-readable instructions stored in a computer-readable storage medium or be performed as a computer-implemented process. As an alternate example, these processes may be encoded as computer-executable instructions and transmitted via a communications medium.

It should be understood that the various techniques described herein may be implemented in connection with hardware or software or, where appropriate, with a combination of both. Thus, the methods and apparatus of the disclosure, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a mobile device, the machine becomes an apparatus for practicing technology of the disclosure. In the case of program code execution on a mobile device, the mobile device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

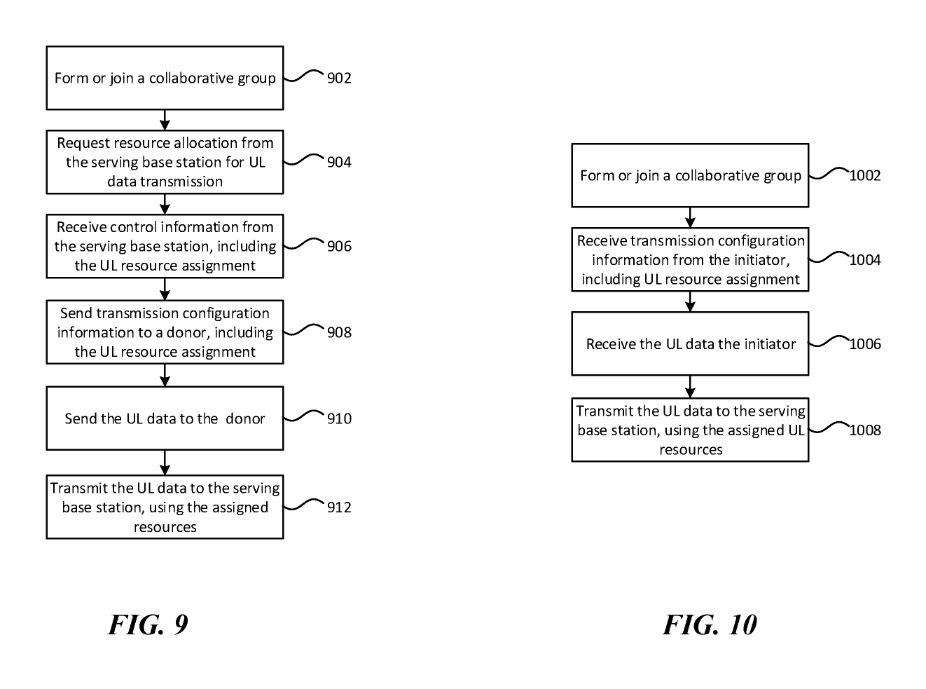

FIG. 9 depicts an exemplary operational procedure for carrying out collaborating transmission by an initiator, including operations 902, 904, 906, 908, 910, and 912.

In operation 902, a mobile device (initiator) forms or joins a collaborative UL group in a specific location, area, or zone. In one embodiment, the collaborative zone is designated or identified by the serving base station or the wireless network that the serving base station is associated with and an identifier is provided or assigned to the collaborative UL group by the serving base station or by the network. In another embodiment, the serving base station sends a control message or a sequence of control messages to the initiator to facilitate the initiator to form or join the collaborative UL group. The control message may include one or more of the following: an indication of allowing collaborative UL transmission, an identifier for the collaborative UL group, a command to join or form the collaborative UL group, an authentication code, an encryption key, and/or an error correction/detection code. In another embodiment, the initiator initiates steps to form or join the collaborative UL group by sending out beacon signals. Upon a response to the beacon signals by a donor, the initiator starts a handshaking procedure with to establish the PTP or local connection with the donor.

In operation 904, when the initiator has data to send to the serving base station, it requests for resources to be allocated or assigned for its UL transmission from the serving base station. In response, the serving base station allocates the UL resource associated with a specific scheduling scheme.

In operation 906, the initiator receives from the serving base station the UL resource allocation or assignment. In one embodiment, the resources are allocated or assigned with dynamic scheduling. In another embodiment, the resources are allocated or assigned with semi-persistent scheduling.

In operation 908, the initiator sends transmission configuration information to a donor. In one embodiment, the configuration information include at least one of these parameters: the serving base station identifier, the initiator identifier, a frame number, a time slot index, a resource block number, an indication of bandwidth for uplink transmission, an indication of normal or extended cyclic prefix, an indication of subcarrier spacing, an indication of a component carrier, an indication of uplink shared channel, an indication of physical uplink control channel (PUCCH) format, an indication of a cyclic shift for a reference signal sequence, an indication of demodulation reference signal configuration, an indication of preamble format, an indication of random access preamble configuration, an indication of sounding reference signal (SRS) configuration, an indication of a group hopping pattern, an indication of an uplink bandwidth configuration, a codeword number, a number of modulation symbols per layer, a number of modulation symbols to transmit on a physical channel, an indication of a frequency hopping function, an indication of transmit power level, an index for the orthogonal spread sequence, a number of antenna ports used for transmission on a channel, an antenna port number, an indication of a precoding matrix, and/or a codebook index.

In operation 910, the initiator sends UL data to the donor for collaboration transmission to the serving base station. In one embodiment, the data is in the format of a transport block, a codeword, or a scrambled codeword.

In operation 912, the initiator transmits the UL data to the serving base station using the scheduled time-frequency resources.

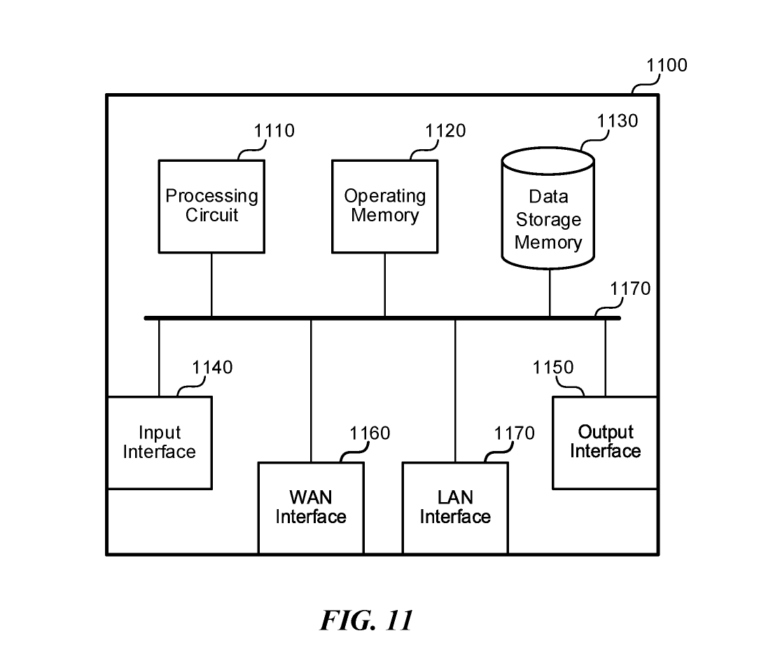

FIG. 10 depicts an exemplary operational procedure for carrying out collaborating transmission by a donor, including operations 1002, 1004, 1006, and 1008.

In operation 1002, a mobile device (donor) forms or joins a collaborative UL group in a specific location, area, or zone. In one embodiment, the serving base station sends a control message or a sequence of control messages to the donor to facilitate the donor to form or join the collaborative UL group. The control message may include one or more of the following: an indication of allowing UL collaborative transmission, an identifier for the collaborative UL group, a command to join or form the collaborative UL group, an authentication code, an encryption key, and/or an error correction/detection code. In another embodiment, the donor receives and responds to a beacon signal.

In operation 1004, the donor sends transmission configuration information from a initiator. In one embodiment, the configuration information include at least one of these parameters: the serving base station identifier, the initiator identifier, a frame number, a time slot index, a resource block number, an indication of bandwidth for uplink transmission, an indication of normal or extended cyclic prefix, an indication of subcarrier spacing, an indication of a component carrier, an indication of uplink shared channel, an indication of physical uplink control channel (PUCCH) format, an indication of a cyclic shift for a reference signal sequence, an indication of demodulation reference signal configuration, an indication of preamble format, an indication of random access preamble configuration, an indication of sounding reference signal (SRS) configuration, an indication of a group hopping pattern, an indication of an uplink bandwidth configuration, a codeword number, a number of modulation symbols per layer, a number of modulation symbols to transmit on a physical channel, an indication of a frequency hopping function, an indication of transmit power level, an index for the orthogonal spread sequence, a number of antenna ports used for transmission on a channel, an antenna port number, an indication of a precoding matrix, and/or a codebook index.

In operation 1006, the donor receives UL data from the initiator for collaboration transmission to the serving base station. In one embodiment, the data is in the format of a transport block, a codeword, or a scrambled codeword.

In operation 1008, the donor transmits the UL data to the serving base station using the time-frequency resources scheduled for the initiator.

FIG. 11 is a high-level illustration of example hardware components of mobile device 1100, which may be used to practice various aspects of the technology. For example, mobile device 1100 may be employed as mobile device 104 of FIG. 1, as mobile device 410 or 412 of FIG. 4, or as any of the other mobile devices discussed herein. In addition, mobile device 1100 may be employed to perform processes of FIGS. 9 and/or 10. As shown, mobile device 1100 includes processing circuit 1110, operating memory 1120, data storage memory 1130, input interface 1140, output interface 1150, wide area network (WAN) interface 1160, and local area network (LAN) interface 1170. These aforementioned components may be interconnected by bus 1180.

Mobile device 1100 may be virtually any type of general- or specific-purpose computing device. For example, mobile device 1100 may be a user device such as a desktop computer, a laptop computer, a tablet computer, a display device, a camera, a printer, or a smartphone. Likewise, mobile device 1100 may also be server device such as an application server computer, a virtual computing host computer, or a file server computer.

Mobile device 1100 includes processing circuit 1110 which may be adapted to execute instructions, such as instructions for implementing the above-described processes or other technology. Processing circuit 1110 may include a microprocessor and/or a microcontroller and may serve as a control circuit. The aforementioned instructions, along with other data (e.g., datasets, metadata, operating system instructions, etc.), may be stored in operating memory 1120 and/or data storage memory 1130. In one example, operating memory 1120 is employed for run-time data storage while data storage memory 1130 is employed for long-term data storage. However, each of operating memory 1120 and data storage memory 1130 may be employed for either run-time or long-term data storage. Each of operating memory 1120 and data storage memory 1130 may also include any of a variety of data storage devices/components, such as volatile memories, semi-volatile memories, non-volatile memories, random access memories, static memories, disks, disk drives, caches, buffers, or any other media that can be used to store information. However, operating memory 1120 and data storage memory 1130 specifically do not include or encompass communications media, any communications medium, or any signals per se.

Also, mobile device 1100 may include or be coupled to any type of computer-readable media such as computer-readable storage media (e.g., operating memory 1120 and data storage memory 1130) and communication media (e.g., communication signals and radio waves). While the term computer-readable storage media includes operating memory 1120 and data storage memory 1130, this term specifically excludes and does not encompass communications media, any communications medium, or any signals per se.

Mobile device 1100 also includes input interface 1140 and output interface 1150. Input interface 1140 may be adapted to enable mobile device 1100 to receive information from an information source. Output interface 1150 may be adapted to provide output to a user. For example, output interface 1150 may include a display and/or the like.

Mobile device 1100 also includes WAN interface 1160 which may be adapted to interface mobile device 1100 to a network such as wireless network 106 (FIG. 1) via base station 102 (FIG. 1). For example, WAN interface 1160 may be configured to communicate with the base station 102 (FIG. 1) of a wireless communication system. WAN interface 1160 may include a network interface card (NIC), a media access control (MAC) interface, a physical level interface (PHY), and/or the like. WAN interface 1160 may also serve as an input and/or output interface for mobile device 1100.

Further, mobile device 1100 may include LAN interface 1170, which may be adapted to interface mobile device 1100 to other mobile device(s), e.g. such that mobile device 1100 can function as a initiator or donor in a collaborative UL group with the other mobile device(s). For example, LAN interface 1170 may be configured to communicate with at least one other mobile device over a local wireless network. LAN interface 1170 may include a WLAN interface (e.g., IEEE802.11 or WiFi), a Bluetooth interface, a NFC interface, or any other suitable interface.

While the above Detailed Description describes certain embodiments of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific embodiments disclosed herein, unless the Detailed Description explicitly defines such terms. Accordingly, the actual scope of the technology encompasses not only the disclosed embodiments, but also all equivalent ways of practicing or implementing the technology.

We claim:

1. A method for transmitting into a wireless communication system, the method comprising:
receiving, by a first transmitter, control information from a receiver in the wireless communication system, the control information indicating time-frequency resources allocated to the first mobile device for data transmission to the receiver;
sending configuration information to a second transmitter in the wireless communication system, wherein the configuration information includes an indication of the time-frequency resources allocated to the first transmitter; and
sending data to the second mobile device, wherein the data is to be transmitted to the receiver using the time-frequency resources allocated to the first transmitter.

2. The method of claim 1, wherein the allocated time-frequency resources are defined by time and frequency indices.

3. The method of claim 2, wherein the time index is associated with a frame number, a subframe number, slot number, or both.

4. The method of claim 2, wherein the frequency index is associated with a resource block number.

5. The method of claim 1, wherein the configuration information includes an identifier associated with the receiver.

6. The method of claim 1, wherein the configuration information includes an identifier associated with the first transmitter.

7. The method of claim 1, wherein the configuration information includes at least one of an indication of bandwidth for uplink transmission, an indication of normal or extended cyclic prefix, or an indication of a component carrier.

8. The method of claim 1, wherein the configuration information includes at least one of an indication of a cyclic shift for a reference signal sequence, an indication of demodulation reference signal configuration, an indication of sounding reference signal (SRS) configuration, or an indication of a group hopping pattern.

9. The method of claim 1, wherein the data to be transmitted to the receiver is in a format of a transport block or a codeword.

10. A mobile device in a wireless communication system comprising:
at least one memory and at least one processor, wherein the at least one memory and the at least one processor are respectively configured to store and execute instructions for causing the mobile device to perform operations, the operations comprising:
receiving control information from a base station in the wireless communication system, the control information indicating a time period and a frequency at which the mobile device is permitted to transmit data into the wireless communication system;
transmitting configuration information to a second mobile device in the wireless communication system, wherein the configuration information includes indication of the time period and the frequency at which the mobile device is permitted to transmit into the wireless communication system; and
transmit data to the second mobile device, wherein the data is to be transmitted to the base station by the second mobile device during the time period and at the frequency at which the mobile device is permitted to transmit into the wireless communication system.

11. The mobile device of claim 10, wherein the operations further comprise:
transmitting, by the first mobile device, the data to the base station during the time period and at the frequency at which the mobile device is permitted to transmit into the wireless communication system.

12. A method for transmitting into a wireless communication system, the method comprising:
receiving, by a first mobile device, configuration information from a second mobile device in the wireless communication system, wherein the configuration information indicating a time and a frequency resource allocated to the second mobile device for transmitting data to a receiver;
receiving, by the first mobile device, data from the second mobile device for transmission to the receiver; and
in response to receiving the data from the second transmitter, transmitting, by the first mobile device, the data to the receiver on behalf of the second mobile device using the time and the frequency resource allocated to the second mobile device.

13. The method of claim 12, wherein at least one of the allocated time resource or frequency resource is defined by at least one of a time index or a frequency index.

14. The method of claim 13, wherein the time index is associated with a frame number, a subframe number, slot number, or both.

15. The method of claim 13, wherein the frequency index is associated with a resource block number.

16. The method of claim 12, wherein the configuration information includes an identifier associated with the receiver, and wherein the configuration information includes an identifier associated with the first mobile device.

17. The method of claim 12, further comprising:
transmitting, by the second mobile device, the data to the receiver using the same time and the frequency resource allocated to the second mobile device.

18. The method of claim 12, wherein the configuration information includes at least one of a bandwidth for uplink transmission, cyclic prefix length, a component carrier, a cyclic shift for a reference signal sequence, demodulation reference signal configuration, sounding reference signal (SRS) configuration, or a group hopping pattern.

19. The method of claim 12, wherein the data to be transmitted to the receiver is in a format of a transport block or a codeword.

20. A mobile device in a wireless communication system comprising:
a first wireless interface configured to communicate with a base station of a wireless communication system;
a second wireless interface configured to communicate with at least one other mobile device over a local wireless network; and
at least one memory and at least one processor, wherein the at least one memory and the at least one processor are respectively configured to store and execute instructions for causing the mobile device to:
receive configuration information via the second wireless interface from a second mobile device in the wireless communication system, wherein the configuration information indicates a time and frequency resource allocated to the second mobile device for data transmission to the base station by the second mobile device; and
receive data via the second wireless interface from the second mobile device; and
transmit the received data via the first wireless interface according to the configuration information.
